(19) United States
(12) Patent Application Publication
(10) Pub. No.: US 2018/0310496 A1
(43) Pub. Date: Nov. 1, 2018

(54) SYSTEM FOR MANAGING SPEED COMMANDS FOR MOTOR-DRIVEN IRRIGATION SYSTEM

(71) Applicant: LINDSAY CORPORATION, Omaha, NE (US)

(72) Inventors: REECE ROBERT ANDREWS, ARLINGTON, NE (US); DERICK JAMES FRAUENDORFER, OMAHA, NE (US); ISAAC WILLIAM WELBORN, BLAIR, NE (US)

(73) Assignee: LINDSAY CORPORATION, OMAHA, NE (US)

(21) Appl. No.: 15/497,881

(22) Filed: Apr. 26, 2017

(51) Int. Cl. A01G 25/16; A01G 25/09; G05B 15/02

(52) U.S. Cl. CPC A01G 25/165; G05B 15/02; A01G 25/092

(57) ABSTRACT

A system for actively managing the implementation of locally and remotely entered speed or application rate commands for an irrigation system. The irrigation system includes drive motors, local and remote speed controllers, and a speed manager. The local speed controller allows for entering a first speed of the irrigation system in terms of a first duty cycle for powering a distal motor. The remote speed controller allows for entering a second speed in terms of a second duty cycle for powering the distal motor. The speed manager determines whether the most recent speed command originated from the local speed controller, in which case the distal motor is run in accordance with the first duty cycle and the second duty cycle is ignored, or from the remote speed controller, in which case the distal motor is run in accordance with the second duty cycle and the first duty cycle is ignored.

### FIELD

The present invention relates to systems for controlling the speeds of irrigation systems, and more particularly, embodiments concern a system for managing the implementation of locally and remotely entered speed or application rate commands for a motor-driven irrigation system.

### BACKGROUND

The motors of motor-driven center-pivot irrigation systems are switched on and off during a cycle in order to achieve an average speed of movement over a series of cycles. The lengths of these on and off periods, which together make a duty cycle, are expressed as percentages of each cycle, and are set using an on/off timer. For example, a user-entered percentage of 25% means that the drive motor will be powered and the irrigation system will move for 25% percent of each cycle, and the drive motor will be unpowered and the irrigation system will be stationary for the remaining 75% of each cycle. The length of the on and off periods determines the speed of the irrigation system, which in turn, determines the amount of water of other fluid applied to crops under the irrigation system while it is stationary. The speed or application rate command can be entered locally using a control panel mounted to the irrigation system, or the speed command can be entered remotely using a remote control product which communicates with the irrigation system.

Users are able to choose between higher-cost, premium-featured remote control products or lower-cost, lower-featured remote control products. Characteristics of typical higher-cost remote control products include the following. A receiver component mounts at the base end of the irrigation system and interfaces with an existing original equipment manufacturer (OEM) digital control panel which includes an existing angle sensor for determining angle information needed for programming and full control of the irrigation system. The overall cost of ownership is higher, with costs including the transmitter component, the digital OEM control panel, and the position-determining system.

Characteristics of typical lower-cost remote control products include the following. The receiver component mounts at the distal end of the irrigation system, which allows for integrating the receiver component, a position-determining system, and control relays into a single enclosure, thereby lowering the overall cost. Most users who choose lower-cost remote control products also choose lower-cost OEM electro-mechanical control panels which do not have an existing angle sensor. An important characteristic of the lower-cost remote control products is the differing implementations of speed commands that are entered locally at the OEM control panel and speed or application rate commands that are entered remotely. The local on/off timer should be set at 100% speed so that continuous power is provided to the drive motor via a contactor. The remote control product can then implement the user's remotely entered speed commands by interrupting the otherwise continuous power to achieve the on and off percentages that result in the desired speed. For example, if a user sends a command via the transmitter component to run the irrigation system at 25% speed, power is provided to the distal motor for 25% of each cycle (for, e.g., 15 seconds of a 1 minute cycle) during which the irrigation system moves, and interrupted for 75% of each cycle (for, e.g., 45 seconds of a 1 minute cycle) during which the irrigation system is stationary.

However, users often experience problems when the local on/off timer is not set to 100%. If the local on/off timer is set at less than 100%, then its cycling of on and off periods is in addition to the cycling called for by the remotely entered speed command. For example, if the user changes the local on/off timer to 25%, then the control panel would no longer provide continuous power to the distal drive motor. If the remote on/off timer is then set at 25%, the result could be an actual speed of 25% of 25%, or 6.25%, which is much lower than expected. The slower the irrigation system moves, the more water is applied. For example, if 25% speed applies 0.50 inches of water, then 25% of 25% speed applies 2.00 inches of water. This unexpected overwatering can damage the crops and cause significant loss of yield.

This background discussion is intended to provide information related to the present invention which is not necessarily prior art.

### SUMMARY

Embodiments of the present invention solve the above-described and other problems and limitations by providing a system for actively managing the implementation of locally and remotely entered speed commands for a motor-driven irrigation system so as to avoid mistakes which can cause slower than expected speeds and greater than expected applications of water or other fluids. Thus, embodiments advantageously provide more intuitive control over the speeds of irrigation systems so that users can be confident that their desired speeds will be properly implemented.

A first embodiment of an irrigation system for applying a fluid to plants may broadly comprise a plurality of drive motors, local and remote speed controllers, and a speed manager. The plurality of drive motors may include a distal drive motor, and be configured to move the irrigation system over the plants. The local speed controller may be configured to allow for entering a first desired speed of the irrigation system in terms of a first control signal for providing power to the distal drive motor. The remote speed controller may be configured to allow for entering a second desired speed or application rate of the irrigation system in terms of a second control signal for providing power to the distal drive motor. The remote speed controller may include a receiver component configured to receive the second control signal, and a transmitter component configured to transmit the second control signal. The speed manager may be configured to determine which of the first control signal and the second control signal was entered most recently. If the first control signal was entered most recently, then the speed manager causes the distal drive motor to run in accordance with the first control signal, and ignores the second control signal. If the second control signal was entered most recently, then the speed manager causes the distal drive motor to run in accordance with the second control signal, and ignores the first control signal.

In one implement of the first embodiment, the distal drive motor may be turned on and off by the speed manager via a contactor, and the distal drive motor may run at a constant revolutions per minute when turned on, and the first control signal may be a first duty cycle and the second control signal may be a second duty cycle. In a second implementation of the first embodiment, the distal drive motor may run at varying revolutions per minute, and the first control signal may specify a first number of revolutions per minute and the second control signal may specify a second number of revolutions per minute.

A second embodiment of an irrigation system for applying a fluid to plants may broadly comprise a base tower, a plurality of drive towers, a span pipe, local and remote speed controllers, and a speed manager. The drive towers may include a distal drive tower located distally relative to the base tower, with each drive tower having a drive motor, including the distal drive tower having a distal drive motor, configured to move the irrigation system over the plants. The span pipe may extend from the base tower and across the plurality of drive towers to the distal drive tower, and may be configured to conduct the fluid to a plurality of outlets located along a length of the span pipe. The local speed controller may be located at the base tower, and configured to allow for entering a first speed command for the irrigation system in terms of a first duty cycle for providing power to the distal drive motor. The remote speed controller may be configured to allow for entering a second speed or application rate command for the irrigation system in terms of a second duty cycle for providing power to the distal drive motor. The remote speed controller may include a receiver component configured to receive a signal communicating the second duty cycle, and a transmitter component configured to transmit the signal communicating the second duty cycle. The speed manager may be configured to determine whether a most recent speed command originated from the local speed controller or from the remote speed controller. If the most recent speed command originated from the local speed controller, then the speed manager may cause the distal drive motor to run in accordance with the first duty cycle, and ignore the second duty cycle. If the most recent speed command originated from the remote speed controller, then the speed manager may cause the distal drive motor to run in accordance with the second duty cycle, and ignore the first duty cycle.

A third embodiment of a center-pivot irrigation system for applying a fluid to crops may broadly comprise a base tower, a plurality of drive towers, a span pipe, local and remote speed controllers, and a speed manager. The base tower may be located at an axis about which the center-pivot irrigation system pivots as the center-pivot irrigation system moves. The drive towers may include a distal drive tower located distally relative to the base tower. Each drive tower may have a drive motor, including the distal drive tower which may have a distal drive motor, configured to move the center-pivot irrigation system about the axis and over the crops. The span pipe may extend from the base tower and across the drive towers to the distal drive tower, and configured to conduct the fluid to a plurality of outlets located along a length of the span pipe. The local speed controller may be located at the base tower, and configured to allow for entering a first speed command in terms of a first percentage of a cycle of time for providing power to the distal drive motor to move the center-pivot irrigation system. The remote speed controller may be configured to allow for entering a second speed or application rate command in terms of a second percentage of the cycle of time for providing power to the distal drive motor to move the center-pivot irrigation system. The remote speed controller may include a receiver component configured to receive a signal communicating the second percentage, and a transmitter configured to transmit the signal communicating the second percentage. The speed manager may be configured to determine whether a most recent speed command originated from the local speed controller or from the remote speed controller. If the most recent speed command originated from the local speed controller, the speed manager may cause a contactor to turn on the distal drive motor for the first percentage of the cycle of time, and ignore the second percentage. If the most recent speed command originated from the remote speed controller, the speed manager may cause the contactor to turn on the distal drive motor for the second percentage of the cycle of time, and ignore the first percentage. Thus, the speed manager may prevent the contactor from turning on the distal drive motor for the second percentage of the first percentage of the cycle of time.

Various implementations of the foregoing embodiments may include any one or more of the following additional features. The fluid may be water, insecticides, herbicides, and/or fertilizers. The first percentage, or first duty cycle, and the second percentage, or second duty cycle, may each be between zero percent and one hundred percent. The local speed controller may include a labeled dial to facilitate entering the first percentage, or first duty cycle. The transmitter component of the remote speed controller may be a mobile computing device, or a handheld communications device, such as a smartphone, running a software application presenting a user interface to facilitate entering the second percentage. The receiver component and the transmitter component of the remote speed controller may communicate via a technology such as radio, cellular, or satellite.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is an isometric view of an embodiment of an irrigation system constructed in accordance with the present invention;

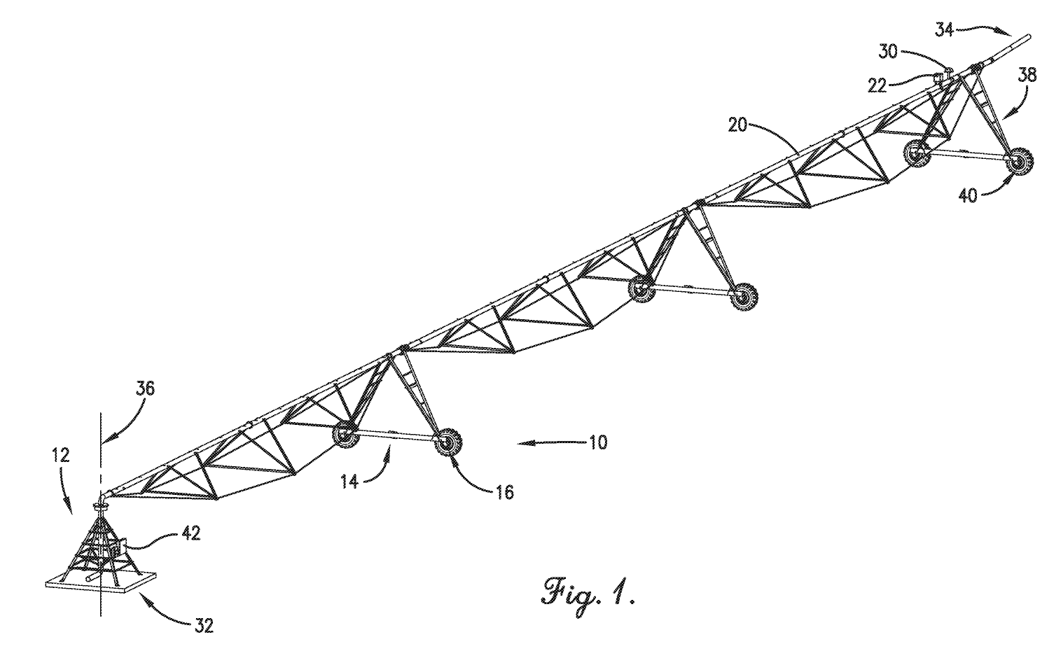

FIG. 2 is an isometric view of a base tower component of the irrigation system shown in FIG. 1; and

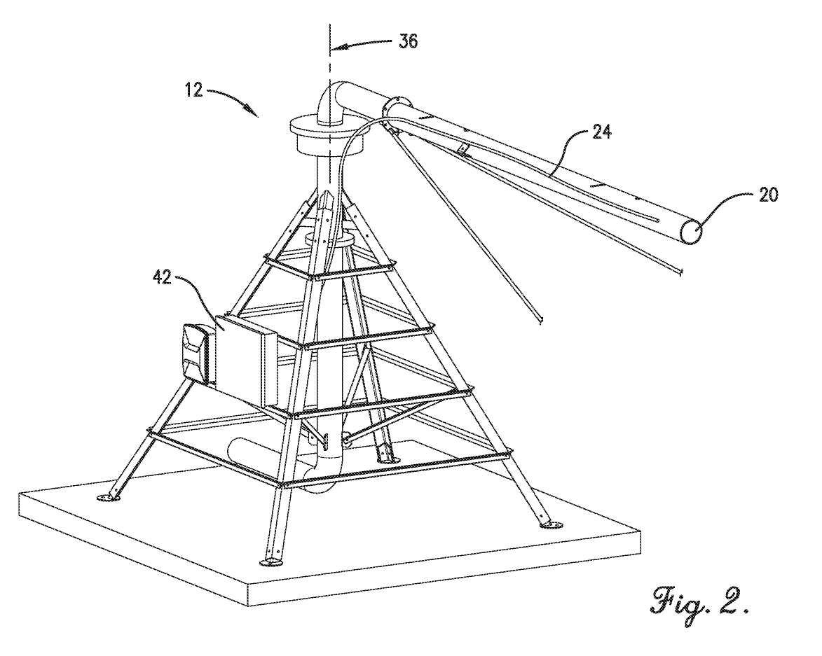

FIG. 3 is a block diagram of components of the irrigation system shown in FIG. 1 for controlling a speed of the irrigation system.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Embodiments may provide a system for actively managing the implementation of locally and remotely entered speed commands for a motor-driven irrigation system so as to avoid mistakes which can cause slower than expected speeds and greater than expected applications of water or other fluids. Thus, embodiments advantageously provide more intuitive control over the speeds of irrigation systems so that users can be confident that their desired speeds will be properly implemented.

Referring to the figures, an embodiment of a system constructed in accordance with the present invention may broadly comprise an irrigation system 10 including a base tower 12; a plurality of drive towers 14; a plurality of electric drive motors 16; a contactor 18; a span pipe 20; a position-determining system 22; at least one voltage line 24; a local speed controller 26; a remote speed controller 28; and a speed manager 30. The irrigation system 10 may be an otherwise largely conventional irrigation system for applying water or other fluids (e.g., insecticides, herbicides, and/or fertilizers) to crops or other plants. For example, the irrigation system 10 may be a center-pivot irrigation system having a base end 32 and a distal end 34, and the base tower 12 may establish an axis 36 about which the irrigation system 10 pivots, or rotates, over a portion or an entirety of a circular area of the crops or other plants.

The plurality of drive towers 14 may structurally support the span pipe 20 and other components of the irrigation system 10, and the plurality of drive motors 16 may drive and otherwise facilitate movement of the irrigation system 10. To that end, a distal drive tower 38 may be associated with a particular distal drive motor 40 of the plurality of drive motors 16, and some or all of one or more intermediate drive towers may be associated with particular intermediate drive motors of the plurality of drive motors 16 for driving the drive towers 14 in such a manner as to make the irrigation system 10 pivot about the axis 36. The drive motors 16 may be intermittently powered and run at constant revolutions per minute (RPM) when powered to achieve a desired speed over a cycle. Alternatively, as discussed below, the drive motors 16 may be constantly powered and run at varying RPMs to achieve the desired speed.

As discussed in more detail below, the distal drive motor 40 associated with the distal drive tower 38 may be turned on and off in a controlled manner to achieve a desired speed of movement, and the intermediate drive motors associated with the intermediate drive towers are in turn controlled by an alignment system. The contactor 18 is configured to accomplish turning the distal drive motor 40 on and off in accordance with a speed control signal which communicates a percentage of time (i.e., as duty cycle) in each cycle during which the distal motor is either on (i.e., receiving power) or off (i.e., not receiving power).

The span pipe 20 may extend from the base tower 12 across the intermediate drive towers to the distal driver tower 38, and provide a conduit for the water or other fluids to various nozzles or other outlets located along its length. The position-determining element 22 may be substantially any suitable system, such as a GNSS system, installed on the irrigation system 10, such as on the span pipe 20 at or near the distal drive tower 38, and configured to determine its own location and communicate that location to one or more (e.g., local and/or remote) control elements for reporting and/or controlling various functions of the irrigation system 10. The position-determining element 22 may determine its location to an accuracy of at least approximately 0.1 of a degree.

The at least one voltage line 24 may extend between the base tower 12 and the contactor 18 located at or near the distal drive motor 40, and may provide a continuous voltage to the contactor 18 when the irrigation system 11 is in forward or reverse modes. In one implementation, there may be two such voltage lines, with a first voltage line providing the continuous voltage having a phase to the contactor 18 when the irrigation system 10 is in the forward mode, and the second voltage line providing the continuous voltage having an opposite phase to the contactor 18 when the irrigation system 10 is in the reverse mode.

The local speed controller 26 may be incorporated into an OEM control panel 42 or otherwise located near or at the base tower 12, and configured to allow a user to enter a first speed command for a first desired speed of movement of the irrigation system 10. As discussed in more detail below, the local speed controller 26 may be configured to allow the user to enter the desired speed of movement in terms of a first percentage of time, or a first duty cycle, during which the distal drive motor 40 is on and the irrigation system 10 is moving in each cycle. To that end, the local speed controller 26 may include a dial, button, switch, or similar mechanism 44 to facilitate the user selecting a desired percentage from a plurality of percentages between 0% and 100%. More specifically, the first percentage, or first duty cycle is communicated to the speed manager 30 which under certain conditions, as described below, may cause the contactor 18 to apply and remove the voltage provided by the at least one voltage line 24 in accordance with the first percentage, or first duty cycle.

The remote speed controller 28 may be similarly configured to allow the user to enter a second speed or application rate command for a second desired speed of movement in terms of a second percentage of time, or a second duty cycle, during which the distal drive motor 40 is on and the irrigation system 10 is moving in each cycle. The second percentage, or second duty cycle, may be equal to, greater than, or less than the first percentage, or first duty cycle. The second percentage, or second duty cycle is communicated to the speed manager 30 which under certain conditions, as described below, may cause the contactor 18 to apply and remove the voltage provided by the at least one voltage line 24 in accordance with the second percentage, or second duty cycle.

The remote speed controller 28 may include a receiver component 48 and a transmitter component 50. The receiver component 48 may be mounted near or at the distal drive tower 38, and configured to receive signals from the transmitter component 50 for controlling operation of the irrigation system 10, including a speed command signal. The transmitter component 50, may be carried with the user, and configured to send the speed command signal to the receiver component 48. In one implementation, the transmitter component 50 may be a mobile computing device, or a handheld communications device, such as a smartphone running a software application which presents a user interface 52 to facilitate the user selecting the desired second percentage from a plurality of percentages between 0% and 100% or an application rate in appropriate units (e.g., inches or millimeters). If the user enters an application rate, then the remote speed controller 28 or other system component may automatically convert the desired application rate into a corresponding speed for the irrigation system, wherein the corresponding speed results in the desired application rate. Thus, it will be appreciated that references herein to speeds, percentages, or duty cycles encompass application rates which are automatically converted into speeds, percentages, or duty cycles. The receiver and transmitter components 48,50 may communicate using radio, cellular, satellite, or other communication technologies. In one implementation, the remote speed controller 28 may be an aspect of the FieldNET® remote irrigation management product by Lindsay Corporation, which includes a remote speed control capability.

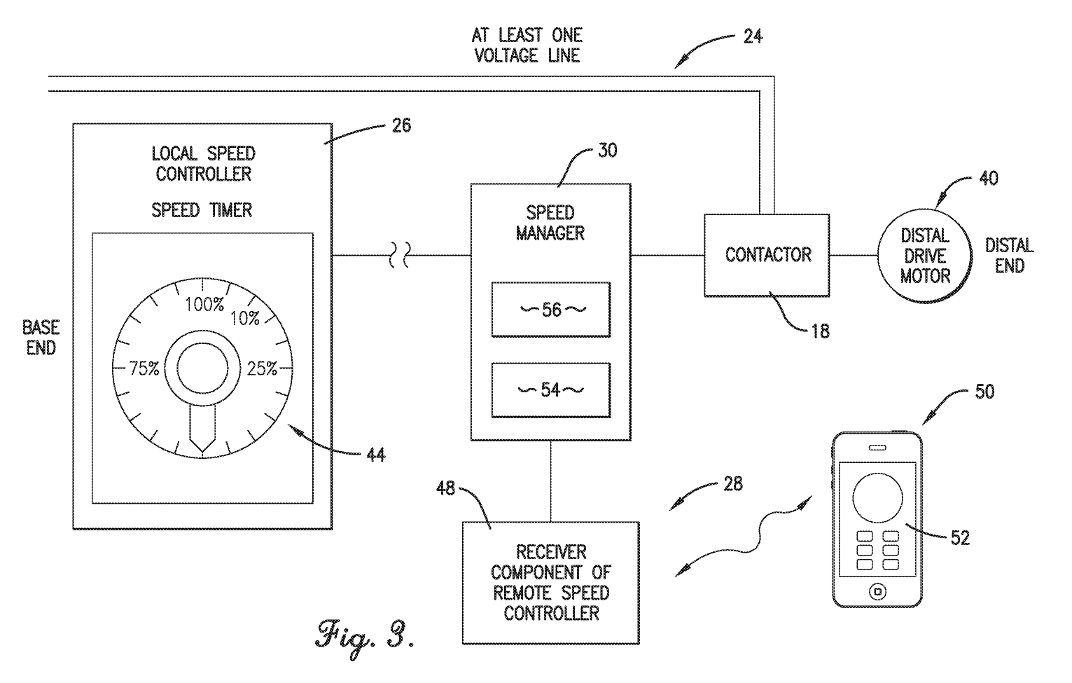

The speed manager 30 may be located near or at the distal drive tower 38, and configured to manage the implementation of speed commands originating from the local speed controller 26 and the remote speed controller 28. The speed manager 30 may broadly include an electronic memory element 54 and an electronic processing element 56. The speed manager 30 may receive or determine using the processing element 56 the first percentage, or first duty cycle, from the local speed controller 26 and store it in the electronic memory 54, and the second percentage, or second duty cycle, from the remote speed controller 28 and store it in the electronic memory 54, and control operation of the contactor 18. In one implementation, shown in FIG. 3, the speed manager 30 may be interposed between the local and remote speed controllers 26,28 and the contactor 18, and may determine the first and second duty cycles over one or more cycles, or at least two cycles. The first duty cycle may be saved as variable Z, and the second duty cycle may be saved as variable Y in the memory element 54. The speed manager 30 may then determine whether the most recent speed command originated from the local speed controller 26 or from the remote speed controller 28. More specifically, the most recent speed command may have originated with the local speed controller 26, as a command entered by the user at the OEM control panel 42. Alternatively, the most recent speed command may have originated with the remote speed controller 28, either as a command entered by the user using the transmitter component 50 or as a command automatically issued by preset plan. The speed manager 30 may then cause the contactor 18 to run the distal drive motor 40 in accordance with the most recent speed command, and ignore the other speed command. More specifically, if the most recent speed command originated from the local speed controller 26, then the speed manager 30 may cause the contactor 18 to run the distal drive motor 40 in accordance with the first percentage, or first duty cycle, and ignore the second percentage, or second duty cycle. Alternatively, if the most recent speed command originated from the remote speed controller 28, the speed manager 30 may cause the contactor 18 to run the distal drive motor 40 in accordance with the second percentage, or second duty cycle, and ignore the first percentage, or first duty cycle. Thus, the speed manager 30 may prevent the contactor 18 from running the distal drive motor in accordance with the second percentage of the first percentage, or the second duty cycle within the first cycle.

In a first example, if Y=30%, Z=100%, and the most recent speed command originated with the remote speed controller 28, then the distal drive motor 40 should receive power and move the irrigation system 10 for 30% of each cycle. In a second example, if Y=30%, Z=100%, and the most recent speed command originated with the local speed controller 26, then the distal drive motor 40 should receive power for 100% of each cycle. In a third example, if Y=50%, Z=25%, and the most recent speed command originated with the remote speed controller 28, then the distal drive motor 40 should receive power for 50% of each cycle. Recalling that the at least one voltage line 24 provides continuous voltage when the irrigation system 10 is in the forward or reverse modes, the first duty cycle need not be 100%, or even higher than the second duty cycle, and could even be 0%, and not affect implementation of the second duty cycle. In a fourth example, if Y=50%, Z=25%, and the most recent speed command originated with the local speed controller 26, then the distal drive motor 40 should receive power for 25% of each cycle. Thus, the speed manager 30 avoids the problem experienced with prior art remote speed control products in which different speed commands entered locally and remotely are not properly reconciled and therefore result in unexpectedly different speeds and unexpectedly different amounts of water or other fluids being applied.

As mentioned, an alternative application for the present technology may involve a continuous movement irrigation system in which the speed is entered at the OEM panel and variable frequency drives (VFDs) control the speeds of the drive motors 16 by the cycling the Hertz. The drive motors 16 may run continuously, and the VFDs may adjust the RPMs to achieve the desired speeds. The principle of the present invention may remain the same—i.e., basing final control of the speed on the determined origin of the most recent speed command.

Another alternative application for the present technology may involve alternatives to the voltage on/off indicator, such as a data wire connection between the OEM panel at the pivot point and the distal end of the irrigation system, or an RF connection between the OEM panel and the distal end.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. An irrigation system for applying a fluid to plants, the irrigation system comprising:
a plurality of drive motors, including a distal drive motor, configured to move the irrigation system over the plants;
a local speed controller configured to allow for entering a first desired speed of the irrigation system in terms of a first control signal for providing power to the distal drive motor;
a remote speed controller configured to allow for entering a second desired speed or application rate of the irrigation system in terms of a second control signal for providing power to the distal drive motor, the remote speed controller including a receiver component configured to receive the second control signal, and a transmitter component configured to transmit the second control signal; and
a speed manager configured to—
determine which of the first control signal and the second control signal was entered most recently,
if the first control signal was entered most recently, cause the distal driver motor to run in accordance with the first control signal, and ignore the second control signal, and
if the second control signal was entered most recently, cause the distal drive motor to run in accordance with the second control signal, and ignore the first control signal.

2. The irrigation system as set forth in claim 1, wherein the fluid is selected for the group consisting of: water, insecticides, herbicides, and fertilizers.

3. The irrigation system as set forth in claim 1, wherein the speed manager controls a contactor which causes the distal drive motor to be turned on and off, and the distal drive motor runs at a constant revolutions per minute when turned on, and the first control signal specifies a first duty cycle and the second control signal specifies a second duty cycle for turning the distal drive motor on and off.

4. The irrigation system as set forth in claim 3, wherein the first duty cycle is expressed as a first percentage of a cycle of time, and the second duty cycle is expressed as a second percentage of the cycle of time, and wherein the first percentage and the second percentage are each between zero percent and one hundred percent.

5. The irrigation system as set forth in claim 1, wherein the distal drive motor is configured to run at varying revolutions per minute, and wherein the first control signal specifies a first number of revolutions per minute and the second control signal specifies a second number of revolutions per minute

6. The irrigation system as set forth in claim 1, wherein the transmitter component of the remote speed controller is a mobile computing device.

7. The irrigation system as set forth in claim 1, wherein the transmitter component of the remote speed controller is a handheld communications device.

8. The irrigation system as set forth in claim 7, wherein the handheld communications device is a smartphone running a software application presenting a user interface to facilitate entering the second control signal.

9. The irrigation system as set forth in claim 1, wherein the receiver component and the transmitter component of the remote speed controller communicate via a technology selected from the group consisting of: radio, cellular, and satellite.

10. The irrigation system as set forth in claim 1, further including a position-determining element mounted on the irrigation system, and configured to determine a geographic location of the position-determining element and to communicate the location to one or more control elements for use in controlling operation of the irrigation system.

11. An irrigation system for applying a fluid to plants, the irrigation system comprising:
a base tower;
plurality of drive towers including a distal drive tower located distally relative to the base tower, with each drive tower having a drive motor, including the distal drive tower having a distal drive motor, configured to move the irrigation system over the plants;
a span pipe extending from the base tower and across the plurality of drive towers to the distal drive tower, and configured to conduct the fluid to a plurality of outlets located along a length of the span pipe;
a local speed controller located at the base tower, and configured to allow for entering a first speed command for the irrigation system in terms of first duty cycle for providing power to the distal drive motor;
a remote speed controller configured to allow for entering a second speed or application rate command for the irrigation system in terms of a second duty cycle for providing power to the distal drive motor, the remote speed controller including a receiver component configured to receive a signal communicating the second duty cycle, and a transmitter component configured to transmit the signal communicating the second duty cycle; and
a speed manager configured to—
determine whether a most recent speed or application rate command originated from the local speed controller or from the remote speed controller,
if the most recent speed command originated from the local speed controller, cause the distal drive motor to run in accordance with the first duty cycle, and ignore the second duty cycle, and
if the most recent speed or application rate command originated from the remote speed controller, cause the distal drive motor to run in accordance with the second duty cycle, and ignore the first duty cycle.

12. The irrigation system as set forth in claim 11, wherein the first duty cycle is expressed as a first percentage of a cycle of time, and the second duty cycle is expressed as a second percentage of the cycle of time, and wherein the first percentage and the second percentage are each between zero percent and one hundred percent.

13. A center-pivot irrigation system for applying a fluid to crops, the center-pivot irrigation system comprising:
a base tower located at an axis about which the center-pivot irrigation system pivots as the center-pivot irrigation system moves;
a plurality of drive towers including a distal drive tower located distally relative to the base tower, with each drive tower having a drive motor, including the distal drive tower having a distal drive motor, configured to move the center-pivot irrigation system about the axis and over the crops;
a span pipe extending from the base tower and across the plurality of drive towers to the distal drive tower, and configured to conduct the fluid to a plurality of outlets located along a length of the span pipe;
a local speed controller located on the base tower, and configured to allow for entering a first speed command in terms of a first percentage of a cycle of time for providing power to the distal drive motor to move the center-pivot irrigation system;
a remote speed controller configured to allow for entering a second speed or application rate command in terms of a second percentage of the cycle of time for providing power to the distal drive motor to move the center-pivot irrigation system, the remote speed controller including a receiver component configured to receive a signal communicating the second percentage, and a transmitter component configured to transmit the signal communicating the second percentage; and
a speed manager configured to—
determine whether a most recent speed or application rate command originated from the local speed controller or from the remote speed controller,
if the most recent speed command originated from the local speed controller, cause a contactor to run the distal drive motor in accordance with the first percentage of the cycle of time, and ignore the second percentage,
if the most recent speed or application rate command originated from the remote speed controller, cause the contactor to run the distal drive motor in accordance with the second percentage of the cycle of time, and ignore the first percentage, and
thereby prevent the contactor from running the distal drive motor in accordance with the second percentage of the first percentage of the cycle of time.

14. The center-pivot irrigation system as set forth in claim 13, wherein the fluid is selected for the group consisting of: water, insecticides, herbicides, and fertilizers.

15. The center-pivot irrigation system as set forth in claim 13, wherein the first percentage and the second percentage are each between zero percent and one hundred percent.

16. The center-pivot irrigation system as set forth in claim 13, wherein the local speed controller includes a labeled dial to facilitate entering the first percentage.

17. The center-pivot irrigation system as set forth in claim 13, wherein the transmitter component of the remote speed controller is a mobile computing device.

18. The center-pivot irrigation system as set forth in claim 13, wherein the transmitter component of the remote speed controller is a handheld communications device.

19. The center-pivot irrigation system as set forth in claim 18, wherein the handheld communications device is a smartphone running a software application presenting a user interface to facilitate entering the second percentage.

20. The center-pivot irrigation system as set forth in claim 13, wherein the receiver component and the transmitter component of the remote speed controller communicate via a technology selected from the group consisting of: radio, cellular, and satellite.
